(19) United States
(12) Patent Application Publication
(10) Pub. No.: US 2010/0233995 A1
(43) Pub. Date: Sep. 16, 2010

(54) SYSTEM AND METHOD OF SELECTIVELY RESTRICTING OPERATIONS OF A MOBILE PHONE IN A TELECOMMUNICATIONS SYSTEM

(76) Inventors: Sathishkumar Gopalaswamy, Frisco, TX (US); Mikael Lindstrom, Plano, TX (US)

Correspondence Address: ERICSSON INC., 6300 LEGACY DRIVE, M/S EVR 1-C-11, PLANO, TX, 75024, US

(21) Appl. No.: 12/305,773

(22) PCT Filed: Jun. 20, 2007
(86) PCT No.: PCT/IB07/01653

§ 371 Date: Dec. 19, 2008

Related U.S. Application Data
(60) Provisional application No. 60/805,497, filed on Jun. 22, 2006.

(51) Int. Cl. H04M 3/16

(52) U.S. Cl. 455/410; 455/466

(57) ABSTRACT

A system and method of selectively restricting usage of a user equipment (UE) in a telecommunications system. The system includes a graphical user interface (GUI) for receiving a plurality of restrictions. Each restriction provides a constraint on use of the UE. The GUI allows an administrator of the UE to select and modify the restrictions. The system also includes a traffic server for determining if usage of the UE is within one of the restrictions. If the UE is within one of the restrictions, the traffic server terminates the call. The restrictions may include a time of the day, day of the week or geographical location.

### CROSS-REFERENCE TO RELATED APPLICATIONS

This application claims the benefit of U.S. Provisional Application No. 60/805,497, filed Jun. 22, 2006 and is hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to communication systems. More particularly, and not by way of limitation, the invention is directed to a system and method of selectively restricting operations of a mobile phone in a telecommunications system.

Mobile phones have completely transformed the world we live in today.

Children have fully embraced mobile phones and are the one of the largest users of mobile phones. For a variety of reasons, many children incur tremendous expenses using their mobile phones. Parents, or another authority in charge (administrator) of the mobile phone (e.g., parent, guardian, company, etc.) desire to main control and restrict usage in a variety of situations. For example, in a school, students are often forbidden from using their mobile phones. However, many students, although there may be consequences, continue to use their phones. Likewise, a company may desire to restrict the use of the mobile phone within the confines of a particular city. In other instances, a parent may not wish the child to use the phone after a particular hour or before a certain time of day. A method and system are needed which enable an administrator to restrict and control the use of the mobile phone.

Although there are no known prior art teachings of an apparatus or system such as that disclosed herein, there is a service data point (SDP) utilized within existing telecommunications system which provides subject matter bearing on the present invention. A normal SDP provides checks of thresholds. If a limit is exceeded or approached, an action is triggers. For example, for prepaid accounts, the subscriber is notified that so many minutes remain. In addition, at a specified time, the phone is disconnected. However, an enhanced SDP (traffic server) is needed which utilizes and checks multiple rules before accomplishing an action.

It would be advantageous to have a system and method which enables an administrator to restrict or control usage of a mobile phone in a telecommunications system. It is an object of the present invention to provide such a system and method.

### BRIEF SUMMARY OF THE INVENTION

In one aspect, the present invention is directed to a system of selectively restricting usage of a user equipment (UE) in a telecommunications system. The system includes a graphical user interface (GUI) for receiving a plurality of restrictions. Each restriction provides a constraint on use of the UE. The GUI allows an administrator of the UE to select and modify the restrictions. The system also includes a traffic server for determining if usage of the UE is within one of the restrictions. If the UE is within one of the restrictions, the traffic server terminates the call. The restrictions may include a time of the day, day of the week, or geographical location.

In another aspect, the present invention is a method of selectively restricting usage of a UE in a telecommunications system. The method begins by receiving a plurality of restrictions. Each restriction provides a constraint on use of the UE. Next, a traffic server determines if usage of the UE is within one of the restrictions. Upon determining if usage of the UE is within one of the restrictions, the UE is restricted from use. An administrator may select and modify the restrictions as desired.

In still another aspect, the present invention is a node for selectively restricting usage of a UE in a telecommunications system. The node receives a plurality of restrictions selected and modified by an administrator of the UE. The node determines if the usage of the UE is within one of the restrictions. If the UE is within one of the restrictions, the UE is restricted from use by the node.

### BRIEF DESCRIPTION OF THE SEVERAL VIEWS OF THE DRAWING

In the following, the features of the invention will be described in detail by showing preferred embodiments, with reference to the attached figures in which:

FIG. 1 is a simplified block diagram of a telecommunications system in a preferred embodiment of the present invention;

FIGS. 2A and 2B are flow charts illustrating a high-level restrictions check performed by the traffic server for voice;

FIG. 3 is a flow chart illustrating a high-level restrictions check performed by the traffic server for data;

FIG. 4 is a simplified block diagram showing a network layout for handling instant messaging (IM), multimedia messaging service (MMS) and data in the telecommunications system;

FIG. 5 is a signaling diagram illustrating the flow of messages for the initial start of a session;

FIG. 6 is a signaling diagram illustrating an ongoing session with intermediate quota requests;

FIG. 7 is a signaling diagram illustrating an intermediate quota request with no reservation remaining;

FIG. 8 is a signaling diagram illustrating a report by the IM gateway when an IM message is sent;

FIG. 9 is a signaling diagram illustrating an IM message report being sent and a new request to the charging control node (CCN);

FIG. 10 is a signaling diagram illustrating an end of session message flow;

FIG. 11 is a signaling diagram illustrating the CSG requesting additional data quota with an empty data cache;

FIG. 12 is a signaling diagram illustrating an IM gateway reporting the sending of an IM with an empty cache;

FIG. 13 is a signaling diagram illustrating a data session start message flow;

FIG. 14 is a signaling diagram illustrating an intermediate quota request when reservations remain;

FIG. 15 is a signaling diagram illustrating an intermediate quota request with no reservation remaining;

FIG. 16 is a signaling diagram of an end of data session message flow;

FIG. 17 is a signaling diagram illustrating a restriction during a data session;

FIG. 18 is a simplified block diagram illustrating an short message service (SMS) call flow;

FIG. 19 is a signaling diagram illustrating an SMS event message flow;

FIG. 20 is a signaling diagram of a restriction condition for an SMS event;

FIG. 21 is a simplified block diagram of content download by subscribers through the QPASS node;

FIG. 22 is a signaling diagram of message flow for a content event; and

FIG. 23 is a signaling diagram illustrating a content restriction condition message flow.

### DETAILED DESCRIPTION OF THE INVENTION

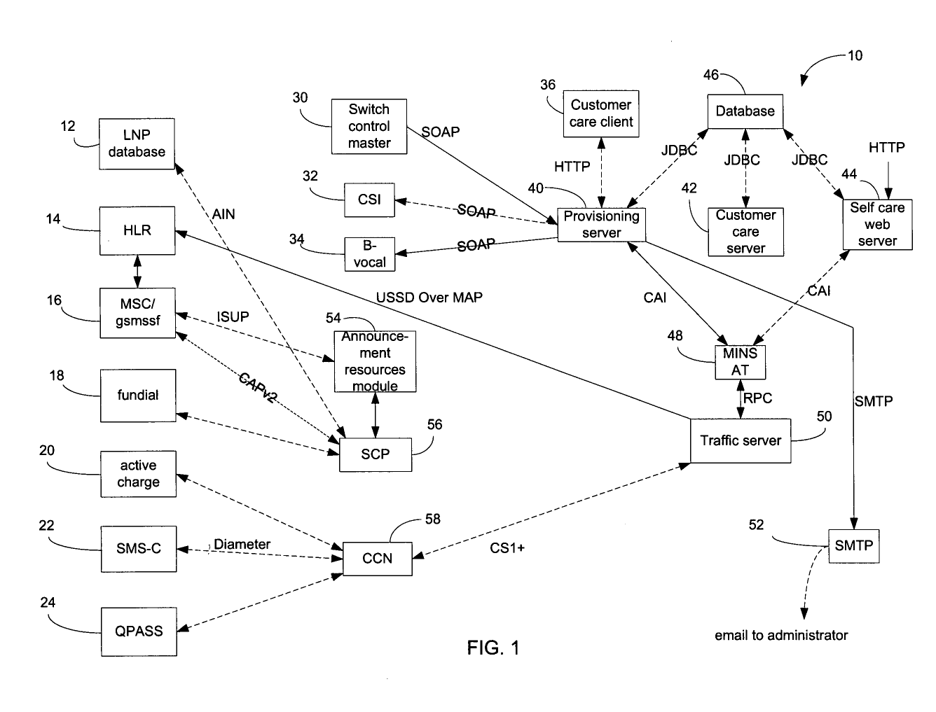

The present invention is a system and method of controlling the usage of a mobile phone. FIG. 1 is a simplified block diagram of a telecommunications system 10 in the preferred embodiment of the present invention. The telecommunications system includes a Local Number Portability (LNP) database 12, a home location register (HLR) 14, a mobile switching center/global system for mobile communication service switching function (MSC/gsmSSF) 16, a fundial 18, an active charge (GPRS) 20, a short message service center (SMS-C) 22, and a QPASS node 24. The system 10 also includes a switch control master 30, a CSI 32, a B-vocal 34, and a customer care client 36. To perform the functions of the present invention, the system also includes a provisioning server 40, a customer care server 42, a self care webserver 44, and a database 46. Additionally, the system includes a MINSAT 48, a traffic server 50, and a short message transport protocol (SMTP) 52. The system further includes an announcement resources module 54 hosted within a gateway MSC (GMSC) node (not shown), a signaling control point (SCP) 56, and a charging control node (CCN) 58.

When a customer, such as a parent, hereinafter known as an administrator, requests a selective restriction service, the service is provisioned in the internal provisional nodes residing within the carrier's internal nodes (e.g., the HLR). Additionally, the switch control master 30 provides data on additional users to the provisioning server 40. The provisioning server 40 performs several key functions. Upon receipt of an “add user” message from the switch control master 30, the provisioning server retrieves the rate plan information from the CSI 32 and then provisions the subscriber in the traffic server 50 and database 46. The provisioning server then sends an e-mail notification to the administrator indicating that the activation is complete. Additionally, a web address is provided for the administrator to access a web interface to populate the restrictions.

The provisioning server 40 handles any “delete user” messages received from the carrier's switch control master 30, whereupon the provisioning server deletes the subscriber in the traffic server and database. Additionally, the provisioning server handles a “change parameter” message received from the carrier's switch control master by updating the parameter for the user in the traffic server database. It also sends an email notification to the administrator indicating that some changes have been made to the administrator's account and/or account holder's parameters. The provisioning server also manages the updating of rate plans for all subscribers by querying the CSI 32 for each subscriber's rate plan information. The provisioning server retrieves a list of subscribers that have reached their minute limits and places this information into the database. This list is compiled by the traffic server 50 and sent to the provisioning server 40 at a specified time period, normally once a day.

Upon receiving an email message indicating that activation of the selective restriction service is complete, the administrator may follow the supplied web address to the web interface. The web interface may then provide for the provisioning of the restrictions. Administrators are preferably authenticated by a single sign-on procedure and then redirected to the self care web server 44. The self care web server provides provisioning of restrictions for the new user, retrieval of current user restrictions, update of user restrictions, retrieval of usage date, interworking with the carrier's servers to complete the single sign on procedure, enable access to a web graphical user interface (GUI) to the self care web GUI, and interworking with the B-vocal server 34 to handle the marketing schemes of the various data packages.

Within the self care web GUI, the administrator is provided a guided path through a set of intuitive screens. Inputs which are not received from the switch control master and are mandatory for the traffic server are preferably presented through the web GUI. The restrictions may then be placed by the administrator through the web GUI.

Upon receipt of an originating or terminating voice call from a carrier's post-paid subscriber, the carrier's network elements (e.g., MSC/gsmSSF 16 or GMSC) identify if the subscriber is utilizing the selective restriction service based on camel subscription information (O-CSI, T-CSI). If the subscriber has subscribed to the service, the call is formatted to the SCP. The SCP 56, which mainly controls the call and announcement handling, forwards the call to the traffic server 50 to check for the restrictions. The SCP also handles the query with the LNP database to assist in identifying if the calls are made between the carrier's subscribers. Thus, the SCP may assist the traffic server in determining if the calls are being charged in the correct minutes bucket (e.g., mobile to mobile calls).

The main functions of the traffic server 50 include storing all the rules and restriction data for the subscriber. Rules are defined as the set of conditions provided by the carrier on how calls should be handled to determine the restrictions. For example, there is a consumption order rule which may be utilized. In this example, if the minutes in the current bucket are used up, the logic dictates that the next bucket in the order is checked. If that bucket has minutes, it allows the call to go though. Restriction data are the limits set by the administrator. The traffic server contains the logic to determine if calls should be restricted based on the rules and restriction data. The traffic server also interfaces with the voice interfacing node (i.e., SCP 56) and data interfacing node (i.e., CCN 58) to communicate if the call or session is allowed.

The traffic server also handles the notifications (USSD) that need to be sent to the subscriber upon reaching threshold limits. This is completed by interfacing with the HLR 14 over the MAP protocol. The traffic server also handles location restrictions and website restrictions (e.g., gambling and porn sites). The traffic server receives the information that a new subscriber is a subscriber of the selective restriction service through the provisioning server 40 and defines the subscriber data in its database 46 for traffic handling.

The traffic server 50, upon checking the rules and restrictions, notifies the SCP 56 whether the call is allowed. The SCP handles the communication to other network elements, either to continue or drop the call based on the reply from the traffic server. In addition, data sessions, which are classified into messages (IM, SMS and MMS) and web browsing data, are triggered though different carrier data nodes towards the traffic server.

IM, MMS and web browsing data are conducted over general packet radio system (GPRS) and when a GPRS session is initiated, an active charge node is activated. This node identifies if the subscriber has subscribed to the service, and if so, identifies the data transport as IM or other data, before forwarding this to the CCN 58 to check the restrictions. Similarly for SMS, the SMS-C 22 is triggered and forwarded to the CCN 58 to check for restrictions. In addition, when subscribers download content, such as ring tones and games, the QPASS node 24 is triggered which in turn, forwards the call to the CCN 58 to check the restrictions. All the data nodes (Openet AC, SMS-C) and content node (QPASS node) communicate to the CCN. The CCN, in general, enables the call control for GPRS, SMS and content-based services communication. The CCN preferably enables communication with the traffic server 50 to provide real-time restriction checks. Upon receiving the restriction check request from the CCN for data/content, the traffic server verifies if any restrictions apply to the session and replies to the CCN if the call is allowed. The CCN then communicates to the data/content node to continue or drop the call accordingly.

Customer care is conducted through the customer care web server 42. The GUI associated with the customer care web sever allows the customer care agent to view what the customer sees as well as additional functionality for troubleshooting and maintenance.

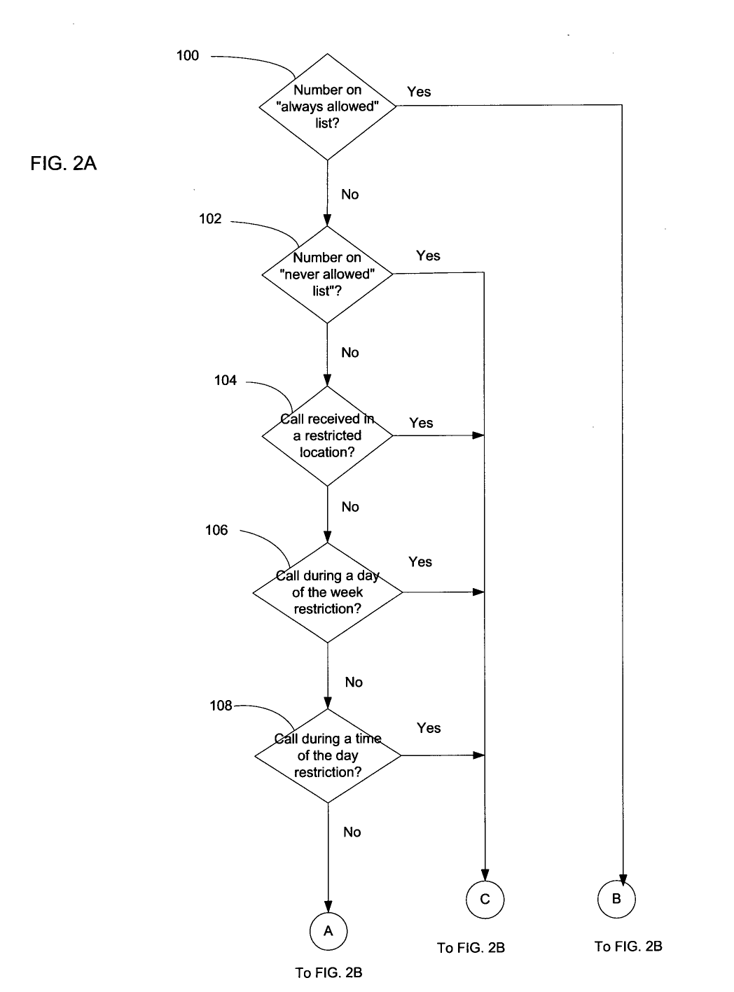

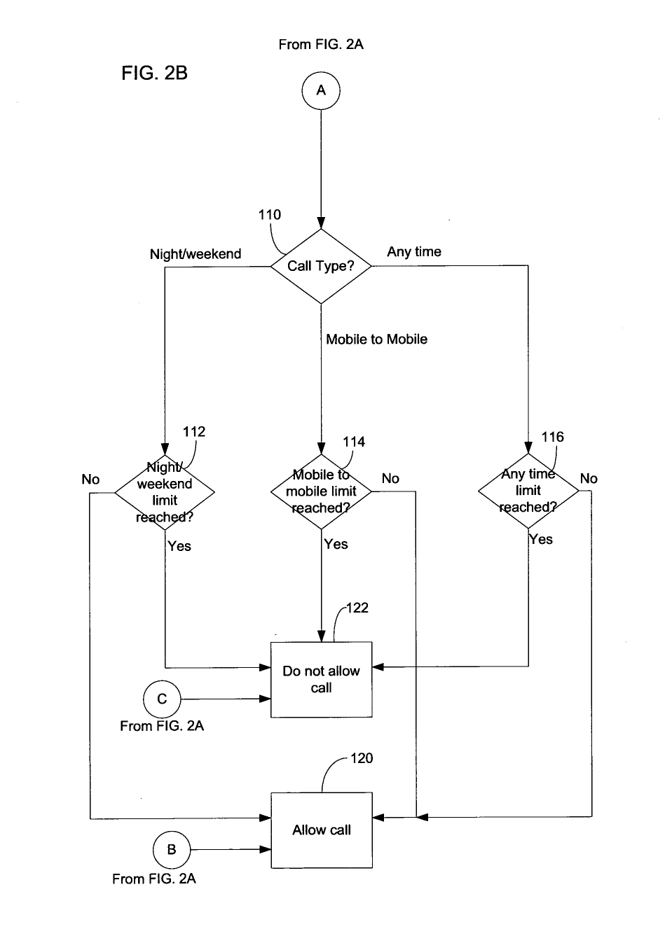

FIGS. 2A and 2B are flow charts illustrating a high-level restrictions check performed by the traffic server 50 for voice. In step 100, it is determined if the calling number is a number on an “always allowed” list. If it is determined that the number is on the “always allowed” list, the method moves to step 120 where the call is allowed. However, in step 100, if it is determined that the number is not on the “always allowed” list, the method moves to step 102 where it is determined if the number is on the “never allowed” list. If it is determined that the number is on the “never allowed” list, the method moves to step 122 where the call is not allowed. However, in step 102 if it is determined that the number is not on the “never allowed list”, the method moves to step 104 where it is determined if the received call is in a location which is restricted by a location restriction. A restricted geographical location may be provided for which the user equipment (UE) may not conduct a call. The administrator may be informed when the UE enters the restricted geographical location. If it is determined that the call is being received in a location where there is a location restriction, the method moves to step 122 where the call is not allowed.

However, in step 104, if it is determined that there is no location restriction, the method moves to step 106 where it is determined if there is a day of the week restriction on calls conducted on specified days. If it is determined that the call is being conducted on a day of the week that is restricted, the method moves to step 122 where the call is not allowed. However, in step 106 if is determined that there is no day of the week restriction, the method moves to step 108 where it is determined if the call is being conducted during a time of day restriction (i.e., during a time of the day where no phone calls are allowed). If it is determined that the call occurs at a specific restricted time of day, the method moves to step 122 where the call is not allowed.

However, if it is determined the call is not made during a restricted time of day, the method moves to step 110 where it is determined what type of call is being conducted. If it is determined that the call is being conducted during the night or weekend, the method moves to step 112 where it is determined if a night/weekend minutes limit has been reached. If it is determined that a limit has been reached, the method moves to step 122 where the call is not allowed. However, if the call has not reached the night/weekend minutes limit, the method moves to step 120 where the call is allowed.

In step 110, if it is determined that the call is a mobile to mobile call (within the carrier's network), the method moves to step 114 where it is determined if a mobile to mobile minutes limit has been reached. If it is determined that this limit has been reached, the method moves to step 122 where the call is not allowed. However, if it is determined that a mobile to mobile minute limit has not been reached, the method moves from step 114 to step 120 where the call is allowed.

In step 110, if it is determined that the call is being conducted during a rate bucket known as “any time” minutes (e.g., calls conducted during any undiscounted time of day), the method moves to step 116 where it is determined if the limit on these minutes has been reached. If this limit has been reached, the method moves to step 122 where the call is not allowed. However, if it is determined that no limit has been exceeded, the method then moves to step 120 where the call is allowed.

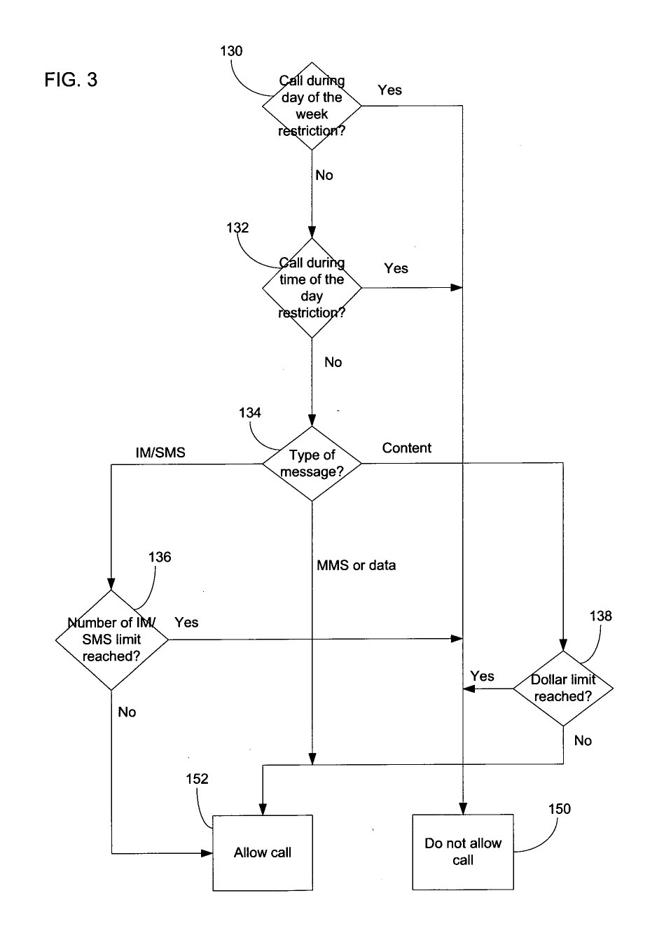

FIG. 3 is a flow chart illustrating a high-level restrictions check performed by the traffic server 50 for data. In step 130, it is determined if a call is being conducted during a restricted day of the week. If it is determined that the call is being conducted during a restricted day of the week, the method moves to step 150 where the call is not allowed. However, if is determined that there is no day of the week restriction, the method moves to step 132 where it is determined if the call is being conducted during a restricted time of day. If it is determined that the call is during a restricted time of day, the method moves to step 150 where the call is not allowed.

However, in step 132, if it is determined that the call is not during a restricted time of day, the method moves to step 134 where it is determined what type of message is being used. If it is determined that the message is an IM/SMS message, the method moves to step 136 where it is determined if an IM/SMS number limit has been reached. If it is determined that an IM/SMS number limit has been reached, the method moves to step 150 where the call is not allowed. However, if is determined that there is no exceeded limit, the method moves from step 136 to step 152 where the call is allowed. In step 134 if it is determined to be an MMS or data call, the method moves to step 152 where the call is allowed. If the call is determined to be a content call (e.g., ring tones or games), the method moves from step 134 to step 138 where it is determined if a money (e.g., dollar) limit has been reached. If it is determined that a money limit has been reached, the method moves to step 150 where the call is not allowed. However, if no money limit has been exceeded, the method moves to step 152 where the call is allowed. In step 134, if the message is an MMS or data message, the method moves to step 152 where the call is allowed.

Currently, there are limitations for sending the correct time where the subscriber is physically located. This applies for terminating calls as the time sent is based on the time zone of where the GMSC is located. However, a GMSC covers several MSCs which could be in different time zones than the GMSC and hence, the time sent may not be correct. To provide a solution, the subscriber may enter a preferred time zone in the web GUI. The time restrictions requested by the administrator are checked against the time zone the subscriber has selected in the GUI and not the time received from the network. Thus, in the preferred embodiment of the present invention, the subscriber is restricted based on the time zone selected in the web GUI and not where the subscriber is physically located. In this embodiment, the subscriber may make the necessary time zone changes in the GUI, and in the case of roaming scenarios, to enable the restrictions to work correctly based on the local time of the subscriber's physical location.

In the preferred embodiment of the present invention, if an originating or terminating call utilizing the selective restriction service is restricted, call forwarding is also restricted. If a user has unconditional forwarding to a “C” number and a terminating call is made from a subscriber's “B” number, the call is routed towards the SDP to check for any restrictions. The calling party number (“A” number) is checked in the “allowed” and “never allowed” list for the user. In addition, other restrictions are also checked as in a normal call termination case. If any of the restrictions are met, then the call is not allowed by the traffic server 50 and the call is released by the SCP 56. If there are no restrictions, then the call is allowed by the traffic server and the call is routed towards the HLR 14. Since it is unconditionally forwarded to the “C” number, the call is routed back to the SCP to check the restrictions for the “C” number. The call is treated as an originating call from the subscriber to the “C” number. The “C” number is checked in the “allowed” and “never allowed” lists for the subscriber. Additionally, other restrictions are checked as it is a handled in the same manner as any other call origination case. The call is allowed or not allowed based on the result of the restriction.

Conditional forwarding corresponds to call forwarding on busy (CFB), call forwarding on non reply (CFNRY) and call forwarding on not reachable (CFNRC). In such a case, if there are no restrictions (“B” number), a terminating call to the subscriber is allowed by the traffic server 50. Assuming one of these above call forwarding conditions are met, the call is routed to the HLR 14 to find the forward number. The call is then routed back to the SCP 56, in a similar fashion as the originating call with the “C” number being the called party. The “C” number is then checked in the “allowed” and “not allowed” lists for the subscriber. Additionally, other restrictions are checked in the normal fashion. If there are restrictions (“B” number), then the call is restricted and the SCP releases the call. The call forwarding leg is not triggered.

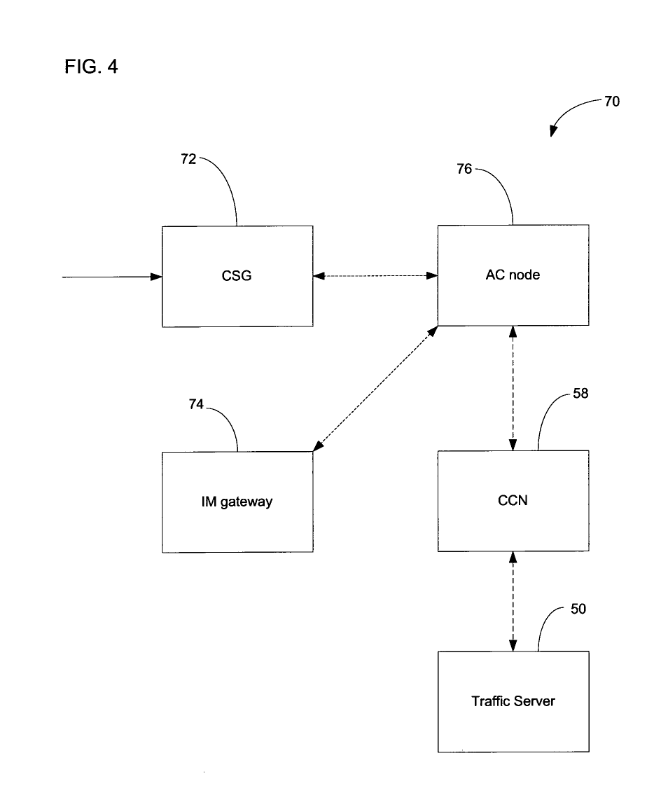

FIG. 4 is a simplified block diagram showing a network layout 70 for handling IM, MMS and data in the telecommunications system 10. A CSG 72, an IM gateway 74, and an active charge (AC) node 76 are pre-existing nodes utilized by a post-paid subscriber. The CCN 56 and traffic server 50 are nodes utilized in the present invention. The CSG is a module that resides in the router. It has the ability to detect GPRS/data transports.

When a subscriber attempts to initiate an IM session, the CSG 72 intercepts the request and checks it against an internal quota database. Since this is the initial session request, no quota exists. The CSG then requests a configurable quota from the AC node 76. The AC node checks whether the subscriber is a subscriber having the selective restriction service. For a subscriber with this service, the AC node first performs a restriction check by sending a request to the CCN 56 attempting to reserve a single IM. The restriction check then verifies that the IM is not during a restricted time of day (ToD) or restricted days of week (DoW) as well as checking how many messages are left in the IM/SMS bucket. If the CCN grants the reservation request (i.e., the initial restriction check is approved), the AC node then cancels the reservation by sending a zero-deduction request to the CCN and grants the request from the CSG to start the IM session. The AC node 76 does not receive notification before an IM is delivered. Rather, the IM gateway 74 notifies the AC node after an IM has been delivered.

Due to the network setup, there are two distinct message flows that control the sending and receiving of IMs. First, the transport flow is initiated when the IM session or any other GPRS data session is initiated. This message flow controls only the data transport aspect of IMs. As part of GPRS phase II, the AC node 76 is aware of the data being transporting. GPRS WAP, MMS, IM Comverse, and IM Openwave are all types of data defined as part of Phase II. In the present invention, IM Comverse and IM Openet are treated in the same fashion. In the second flow of messages, the AC node repeats the transport session check every X minutes where X is an operator defined until the session is closed. The sending and receiving of IMs is reported to the AC node as a post-event (i.e., the IM gateway tells the AC node it has delivered or sent an IM). The AC node checks for any restrictions and if the CCN denies the request, the AC node instructs the CSG 72 to terminate the IM session.

The AC node request IMs from the CCN in groups of five in order to decrease signaling. When the subscriber uses up this limit, the CSG sends a new IM quota request to the AC node. In addition, an inactivity monitor tasked within the AC node closes inactive IM sessions after a configurable time interval.

If the subscriber has met one of the restriction conditions, then a “not allowed” answer is returned to the AC node. The AC node then requests that the CSG 72 terminate the IM session and proceed with further handling as required by the carrier.

If the deductions are not successful (since IMs are not reserved and IM/SMS buckets are common), then the CCN returns a “service-denied” answer to the AC, which stops further IM sessions. The AC also creates a call data record (CDR) for the session, which ends up as a charge on the post-paid subscriber's bill.

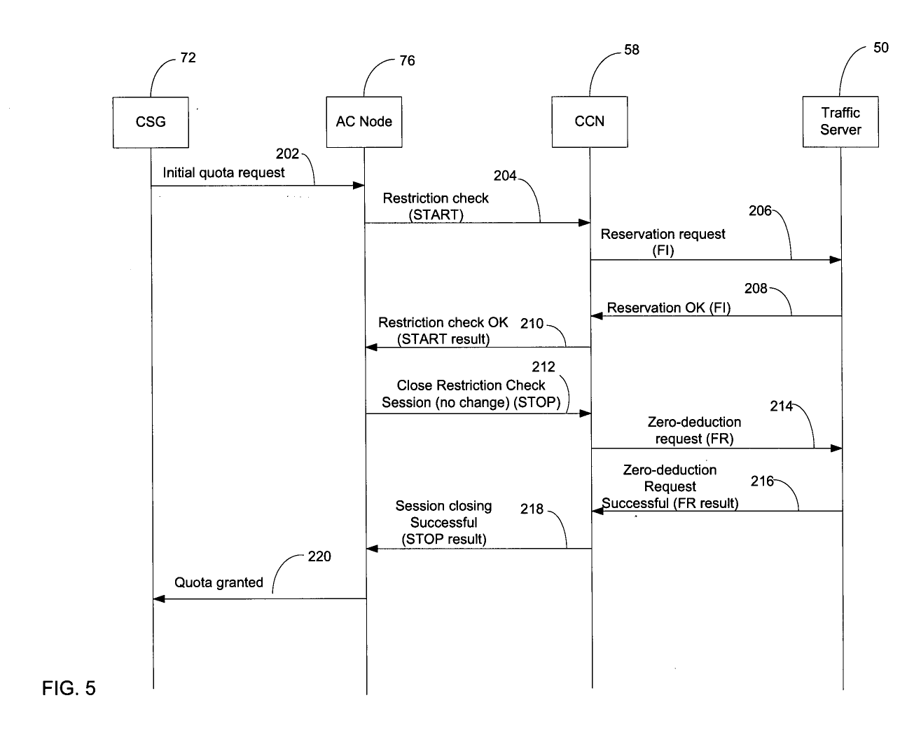

When the user attempts to start a session for IM, the CSG 72 intercepts the request and sends a request to the AC node 76. FIG. 5 is a signaling diagram illustrating the flow of messages for the initial start of a session. The CSG 72 first sends a quota request 202 to the AC node 76. The AC node then checks the types of message. If the subscriber is utilizing the selective restriction service and the message type is an IM, then the AC node requests an IM message y sends a Start message 204 to the CCN 58. The message requests one IM from the CCN. The CCN then sends a First Interrogation (FI) reservation request 206 to the traffic server 50. On receiving the FI, the restriction conditions for the subscriber are checked by the traffic server. If there are no restrictions to be applied, the traffic server reserves one IM as requested and sends a “successful” reply to the CCN by sending a FI reservation OK message 208 to the CCN. The CCN then sends a restriction check OK (START result) message 210 to the AC node. The AC Node then grants the CSG the requested number of kilobytes after receiving the message 220 by sending a quota granted message to the CSG. The AC node sends a close restriction check session (no charge) (STOP) message 212 to the CCN with the used service units of zero to free up the reservation. A zero-deduction request (FR) message 214 is then sent from the CCN to the traffic server. The traffic server responds by sending a zero-deduction request successful (FR result) message 216 to the CCN. The CCN sends a session closing successful (STOP result) message 218 to the AC node.

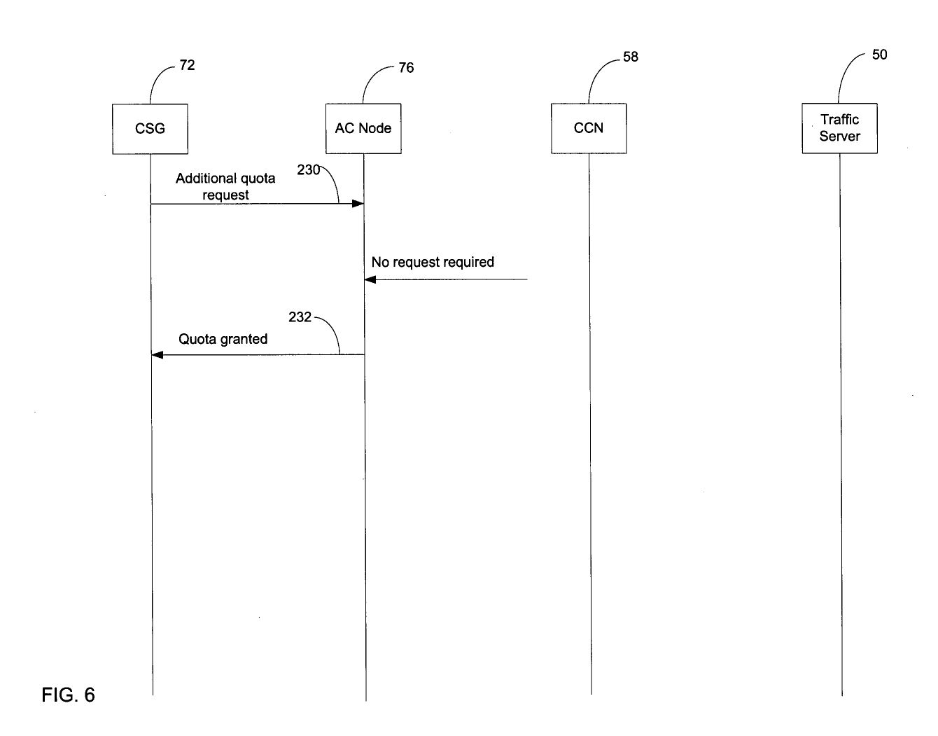

FIG. 6 is a signaling diagram illustrating an ongoing session with intermediate quota requests. As the user continues the IM session, the initial quota of data allocated to the CSG is used up. The CSG 72 then request another additional quota request 230 from the AC node 76. The AC may grant the request from the CSG by sending a quota grant message 232 without checking with CCN 58 since it is the number of IMs that are controlled and not the number of kilobytes.

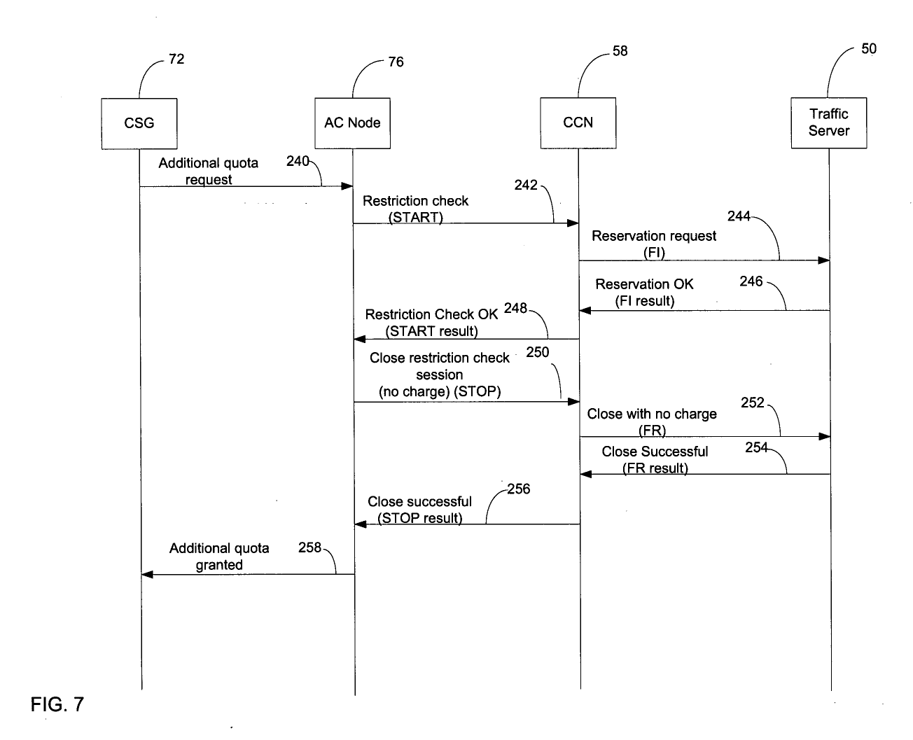

The AC node may re-check the restrictions on a regular basis, although not every time the CSG requests a quota. The trigger for a restriction check may be a certain amount of data sent, a certain time elapsed or both. FIG. 7 is a signaling diagram illustrating an intermediate quota request with no reservation remaining. First, the CSG 72 sends an additional quota request 240 to the AC node 76. In the case where the AC node determines another restriction check is needed, the AC node then sends a restriction check request (START) 242 to the CCN 58. A reservation request (F1) message 244 is sent to the traffic server 50. On receiving the request, the traffic server again checks all the restrictions. The traffic server checks if there are any day of week and/or time of day restrictions based on the new time (and day) that the new request arrived. In addition, the traffic server also checks that the IM/SMS bucket is not empty. If the check is successful, the traffic server performs a new reservation and sends a “successful” reply (Reservation OK message 246) to the CCN to continue the session. The CCN then sends a restriction check OK (Start result) message 248 to the AC node. The AC node responds by sending a close restriction check session (No charge) (STOP) message 250 to the CCN to free up the reserved IM. The CCN sends a close with no charge (FR) message 252 to the traffic server. The traffic server sends a close successful (FR result) message 254 to the CCN. The CCN sends a close successful (STOP result) message 256 to the AC node. The AC node then sends an additional quota granted message 258 to the CSG.

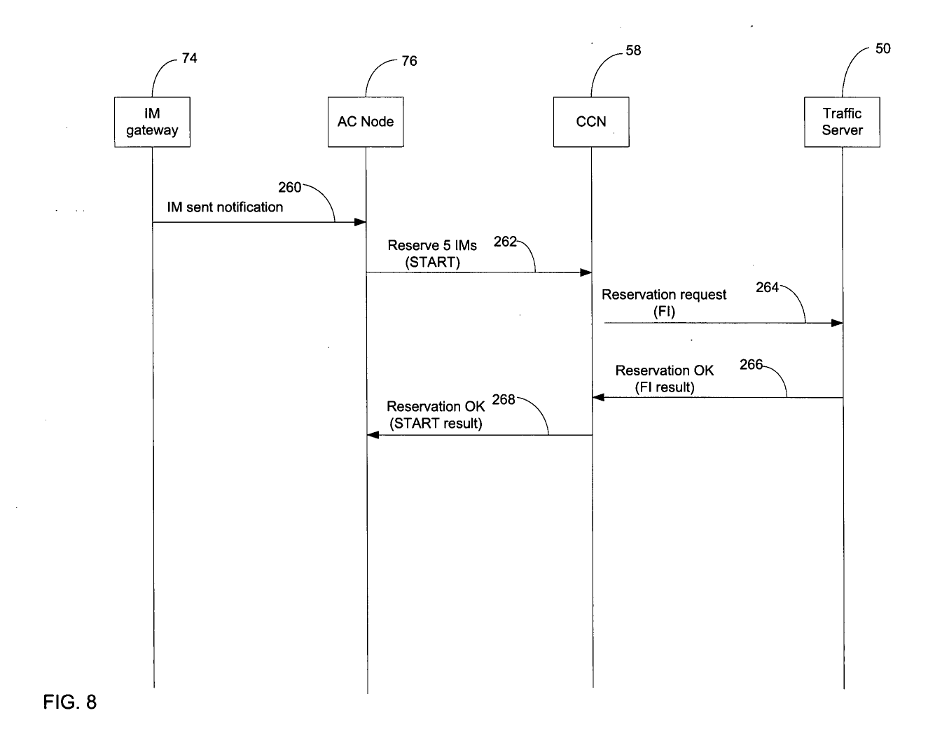

FIG. 8 is a signaling diagram illustrating a report by the IM gateway when an IM message is sent. The IM gateway 74 reports that an IM has been sent by sending an IM sent notification message 260 to the AC node 76. The AC node then reserves 5 IMs (configurable) on the network by sending a reserve 5 IMs (START) message 262 to the CCN 58. The CCN sends a reservation request (F1) message 264 to the traffic server 50. The traffic server then sends a reservation OK (F1 result) message 266 to the CCN. The CCN sends a reservation OK (START result) message 268 to the AC node.

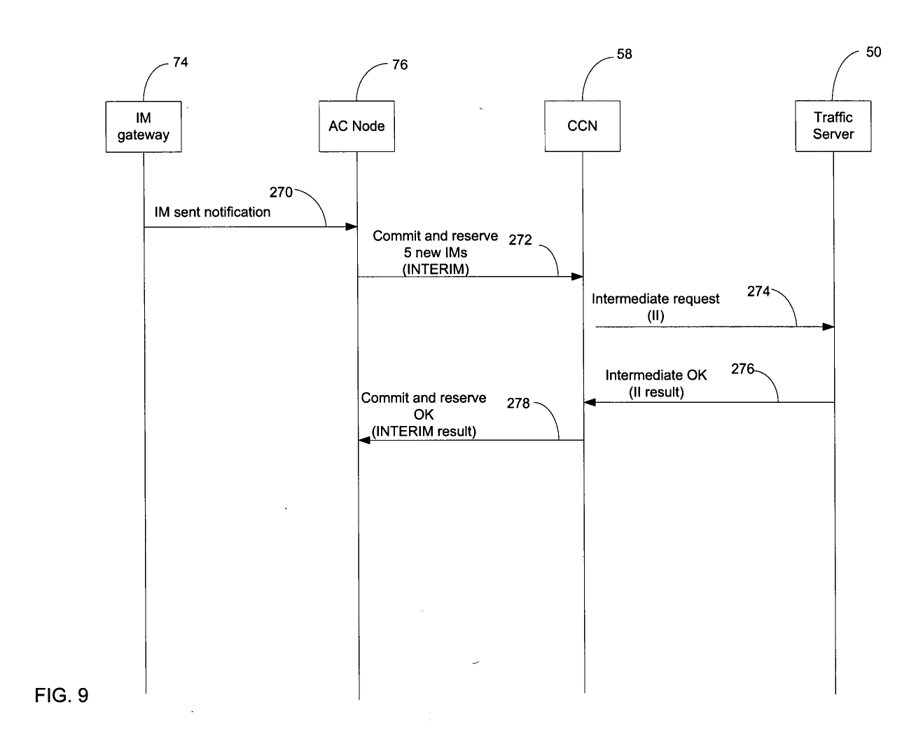

The traffic server 50 then checks the IM message bucket against the IM limit and if the limit is not exceeded, the traffic server reserves the requested 5 IMs. The AC node 76 keeps 4 IMs in its cache for future IM events receiver from the gateway. This is done to reduce load on the network. When the next IM message notification arrives from the IM gateway, the AC deducts it from the remaining message in its cache without sending a request to the CCN. Once the AC node cache has reached zero, the AC node commits the 5 reserved IMs and request 5 more IMs. FIG. 9 is a signaling diagram illustrating an IM message report being sent and a new request to the CCN. An IM sent notification message 270 is sent from the IM gateway 74 to the AC node. In this situation, the IM cache is at zero. The AC node 76 then sends a commit and reserve 5 new IMs (INTERIM) message 272 to the CCN 58. The CCN sends an intermediate request commit previous reservation and reserve 5 additional IMs message 274 to the traffic server 50. The traffic server then sends an intermediate OK message 276 to the CCN. The CCN sends a commit and reserve OK (INTERIM result) message 278 to the AC node where the IM cache is now four. In the preferred embodiment of the present invention, the CCN and traffic server provide a best effort reservation which means that if the subscriber bucket has less than 5 IM/SMS remaining the request is still successful. However, the field “granted-service-units” in the reply to the AC node contains the actual number of reserved IMs. The AC node may need to verify the number in “granted-service-units” and use that to top up its internal cache.

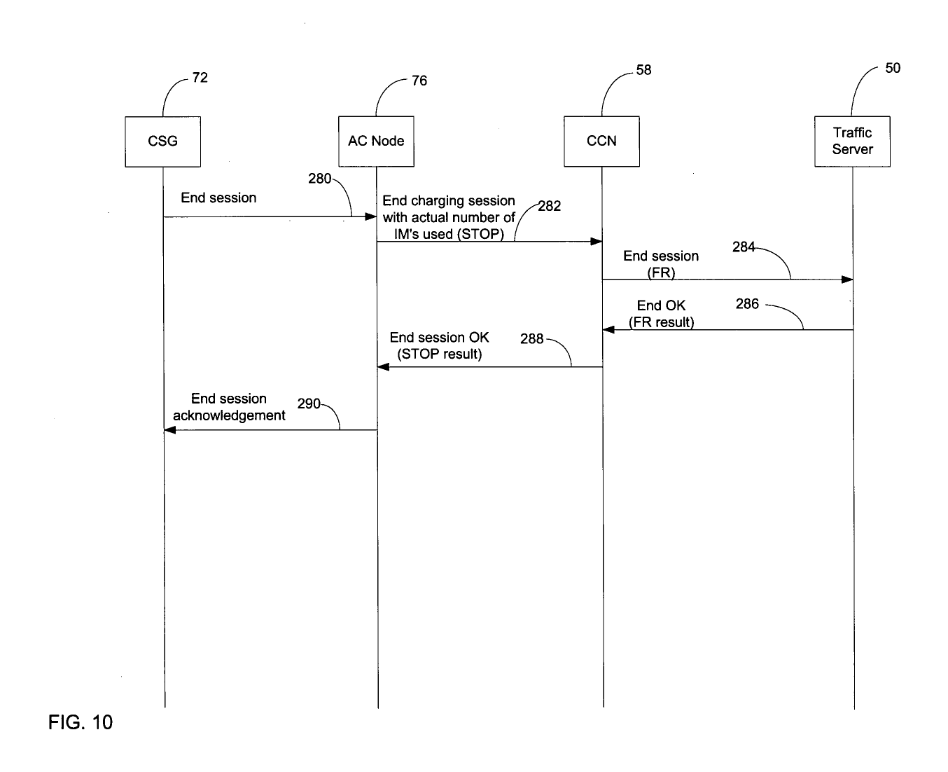

FIG. 10 is a signaling diagram illustrating an end of session. The session ends whenever the user terminates the IM session or there has been no activity for a set period of time. At the IM session end, the CSG 72 sends an end of session message 280 to the AC node 76 indicating the IM session has ended. The AC node then calculates how much of the IM message previously reserved was actually used and then sends a STOP message 282 to the CCN 58. The CCN sends a final report (FR) message 284 to the traffic server 50 to finalize the number of messages to be deducted from the IM bucket. Once the CCN receives a response (FR result message 286) from the traffic server, the end-of-session is conveyed to the AC node by sending a STOP result message 288. The AC node then generates a CDR for post-processing by sending an end session acknowledgement message 290 to the CSG. Since there is a current requirement to send notifications to the subscribers if they are reaching a predefined threshold level, the traffic server may check if the subscriber has reached the thresholds. If the thresholds have been reached, a USSD notification is sent to the subscriber indicating that the threshold limits have been reached. In the preferred embodiment of the present invention, the traffic server actually sends the USSD information to the HLR for further delivery to the subscriber. The USSD is forwarded to the MSC/VLR where the subscriber is registered. The threshold level is provided by the carrier and may be defined on a system level in the traffic server logic. The option to change this threshold may not be available to the administrator, but the administrator may have the option in the GUI to opt out of the threshold notification.

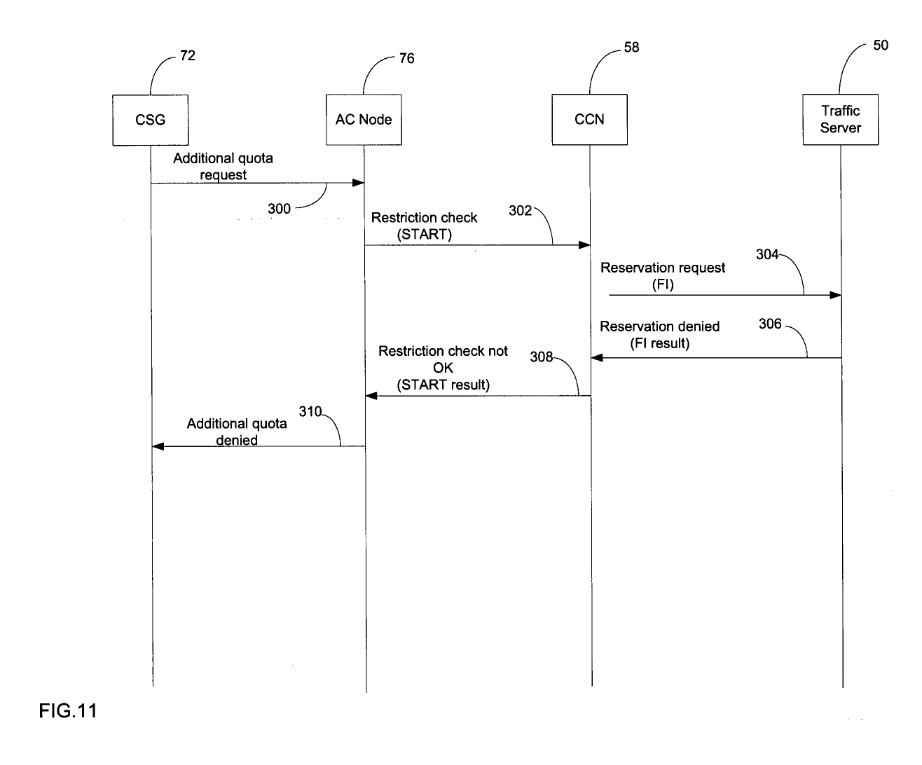

FIG. 11 is a signaling diagram illustrating the CSG 72 requesting additional data quota and the AC node data cache is empty. The CSG sends an additional quota request message 300 to the AC node. The AC node performs a restriction check by sending a START message 302 to the CCN. The CCN sends a reservation request 304 to the traffic server. The traffic server sends a reservation denied message 306 to the CCN. The CCN then sends a START result message 308 to the AC node indicating that the restriction check was not successful. The AC node then sends an additional quota denied message 310 to the CSG.

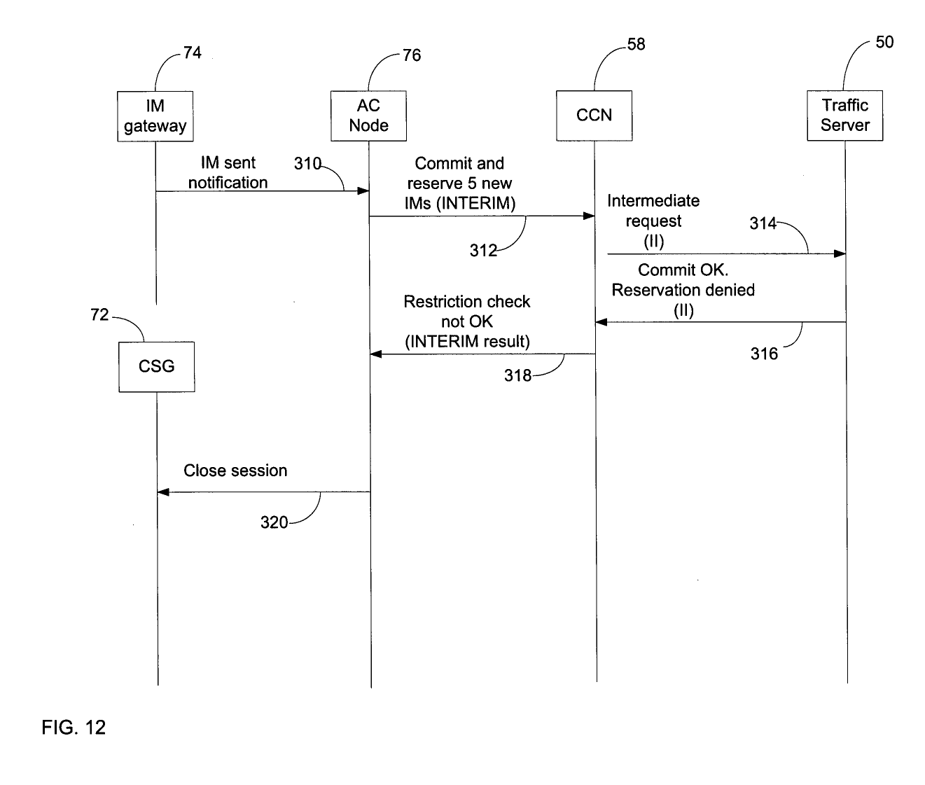

FIG. 12 is a signaling diagram illustrating an IM gateway reporting the sending of an IM with the AC IM cache being empty. The IM gateway 74 sends an IM sent notification message 310 to the AC node 76. The AC node has a zero cache. The AC node then sends a commit and reserve 5 new IMs (INTERIM) message 312 to the CCN 58. The CCN sends and intermediate request commit previous reservation and reserve 5 additional IMs message 314 to the traffic server 50. The traffic server responds by sending a commit OK reservation denied message 316 to the CCN. The CCN sends a restriction check not OK message 318 to the AC node. The AC node then sends a close session message 320 to the CSG 72. The above discussed denial of service may be triggered by one or more of the following conditions: time of day restriction entered, day of week restriction entered, and number of IMs left in the IM bucket is zero. The rejection is applicable during or before the session.

In regards to MMS messages, in the preferred embodiment of the present invention, MMS message are not counted. Therefore, only the time of day and day of week restrictions apply. In addition, the call flow scenarios are identical to the GPRS data flows.

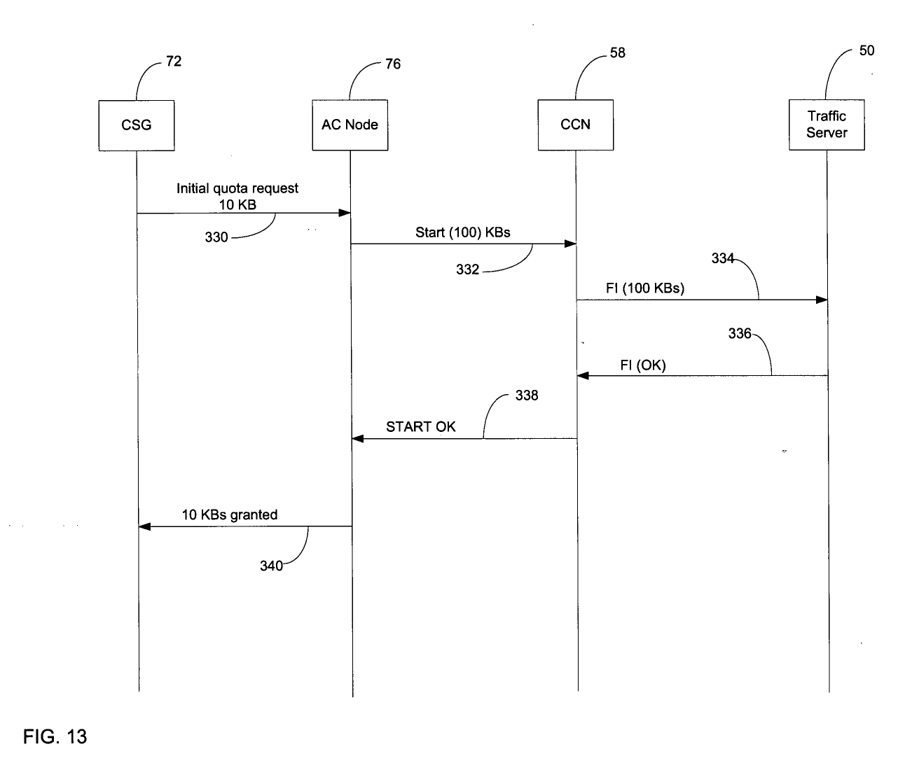

FIG. 13 is a signaling diagram illustrating data session start message flow. When the user attempts to start a GPRS/data session for other than IM messages (e.g., web browsing or MMS), the CSG 72 intercepts the request and sends a quota request message to the AC node. The CSG starts by sending a quota request message 330 to the AC node 76. The AC checks if the subscriber is a subscriber of the selective restrictive service. If so, the AC checks the type of data and, for GPRS/MMS, sends a START message 332 to the CCN 58 requesting a quota of kilobytes. The CCN sends a First Interrogation (FI) request 334 to the traffic server 50 to check restrictions. On receiving the FI message, the restriction conditions for the subscriber are checked by the traffic server (i.e., the day of week and time of day restrictions are checked). If there are no applicable restrictions, the traffic server sends a “successful” reply, FI (OK) message 336, to the CCN. Quota of kilobytes requested by the AC node is usually a larger number than what is requested by the CSG to decrease signaling. The CCN and the traffic server actually do not count the kilobytes being requested by the AC node. No matter what number of kilobytes the AC node requests from the CCN and traffic server, it will receive a successful response as long as the subscriber has no time of day or day of week restrictions. The CCN sends a START OK message 338 to the AC node. The AC node then grants the CSG the requested number of kilobytes after receiving a “successful” response from CCN by sending a granted message 340.

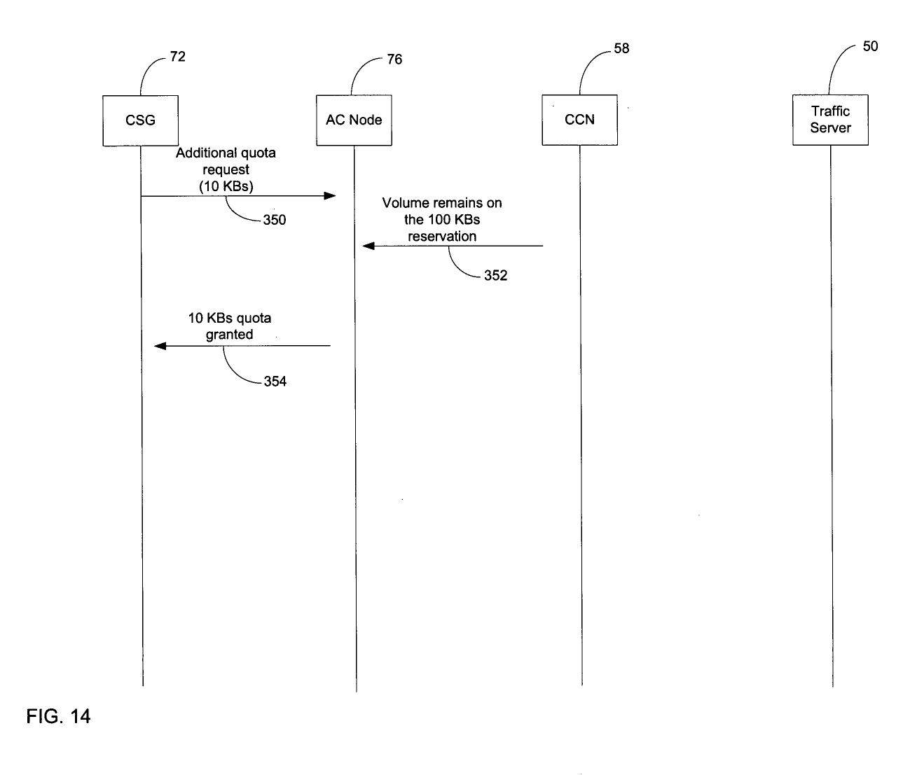

FIG. 14 is a signaling diagram illustrating an intermediate quota request when reservations remain. As the user surfs the web and/or performs data downloads, the initial 10 kilobytes may be used up. CSG 72, at 350, may then request another 10 kilobytes from AC node 76. AC node 76 checks how much of the 100 kilobytes reservation remains and if more than 10 kilobytes remain, the request is granted by checking CCN 58 at 352. For this type of intermediate request, no checks of restrictions are necessary. If a time/day restriction appears during this additional check, the call is still allowed until all the kilobytes are used. At 354, the 10 kilobytes quota is granted. However, if the quota request from the AC node is low, it will trigger inquiries to the traffic server.

In addition, if the data is unused, (i.e., idling), then the CSG preferably should timeout the session. The AC node returns the unused kilobytes to the traffic server in order to properly follow the protocol even though the traffic server does not actually keep track of used kilobytes.

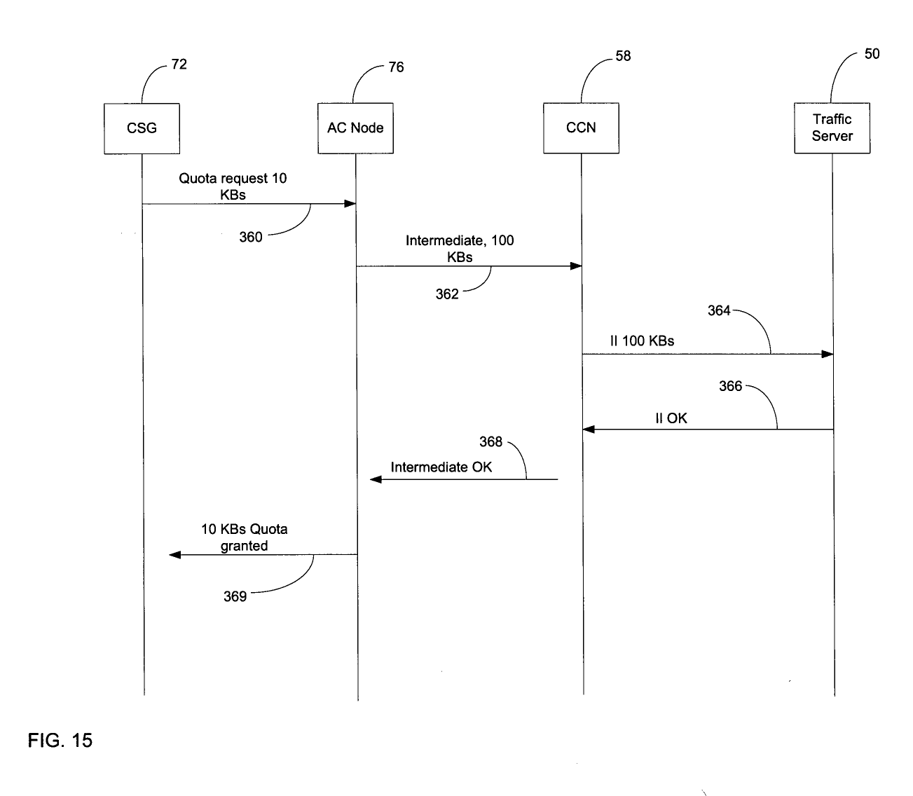

FIG. 15 is a signaling diagram illustrating an intermediate quota request with no reservation remaining. In an example where a 100 kilobytes reservation is used up, a quota request of 10 kilobytes is sent at 360 from the CSG 72. The AC node 76 sends an intermediate request 362 to the CCN 58.

The request is then forwarded at 364 to the traffic server 50. The traffic server then checks all the restrictions, and performs a new reservation of the kilobytes requested. The intermediate request also finalizes the charge of the previous reservation. The traffic server then replies to the CCN at 366. The CCN sends an intermediate OK message 368 to the AC node. The AC node then grants the 10 kilobyte quota at 369.

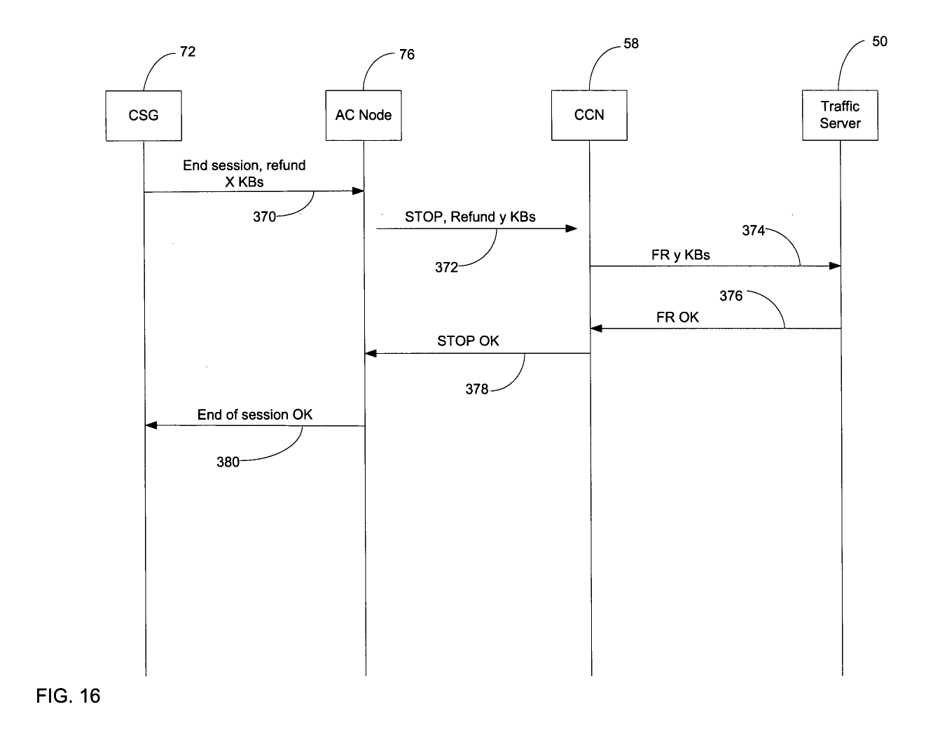

FIG. 16 is a signaling diagram of an end of data session. The session ends whenever the user terminates the GPRS/data session or there has been no activity for a set period of time. The idle timeout resides in the CSG 72. At end of session, the CSG sends a end of session message 370 to the AC node 76 indicating the session has ended and how much of the last quota of 10 kilobytes was not used and would be refunded. The AC node calculates how much of its last 100 kilobytes PPS reservation was used and sends a STOP message 372 to the CCN 58. The CCN sends a Final Report (FR) message 374 to the traffic server 50 to close the session. The traffic server sends a response 376 to the CCN. Once the CCN receives a response from the traffic server, the end of session is conveyed to the AC node at 378. The AC node then generates a CDR for post processing at 380.

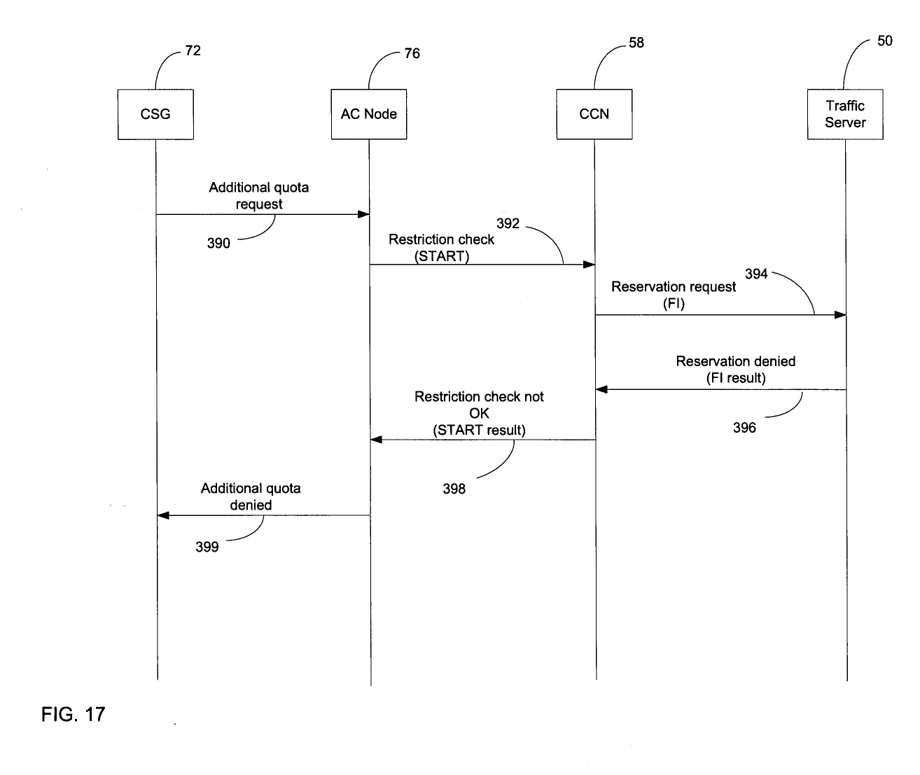

FIG. 17 is a signaling diagram illustrating a restriction during a data session. In this situation, the user starts a GPRS session during a non-restricted period and then enters a restricted period. Once the traffic server denies the additional quota request, the CGS may terminate the GPRS session. The CSG 72 sends an additional quota request message 390 to the AC node 76. The AC node sends a START message 392 to the CCN 58. The CCN sends a reservation request 394. The traffic server 50 responds with a reservation denied message 396 to the CCN. The CCN sends a START result message 398 to the AC node. The AC node then sends an additional quota denied message 399 to the CSG.

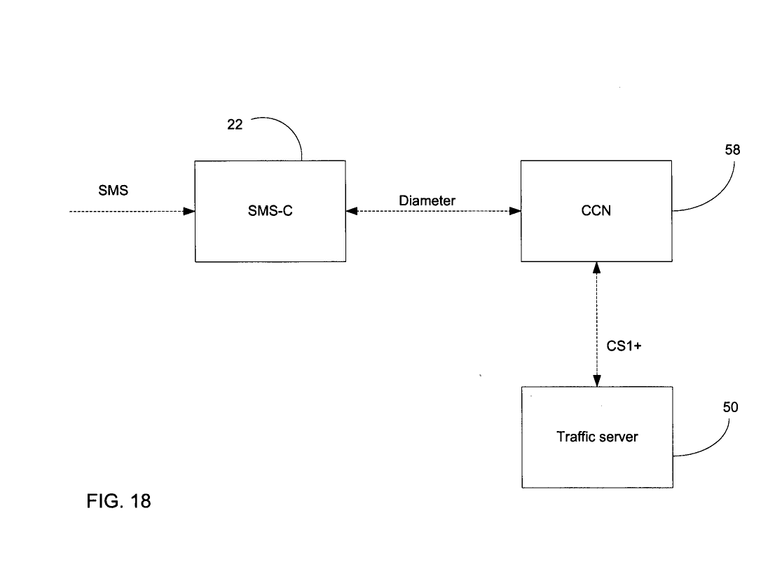

FIG. 18 is a simplified block diagram illustrating SMS call flow. When an SMS is initiated or terminated from/to a postpaid subscriber, the call is routed to the SMS-C 22. If the subscriber has the selective restrictive service, the call is routed to the CCN 58 to check if the SMS event should be allowed or not. The CCN forwards this request to the traffic server 50, which has all the rules and restrictions stored for SMS which were set by the administrator through the GUI. If the restrictions (day of week, time of day or any other limits) are not reached, then a “successful” reply is sent to the CCN which, in turn, sends it to the SMS-C to continue the SMS event. IM and SMS are deducted from the same bucket within the traffic server (IM/SMS bucket). SMS are deducted by number of events.

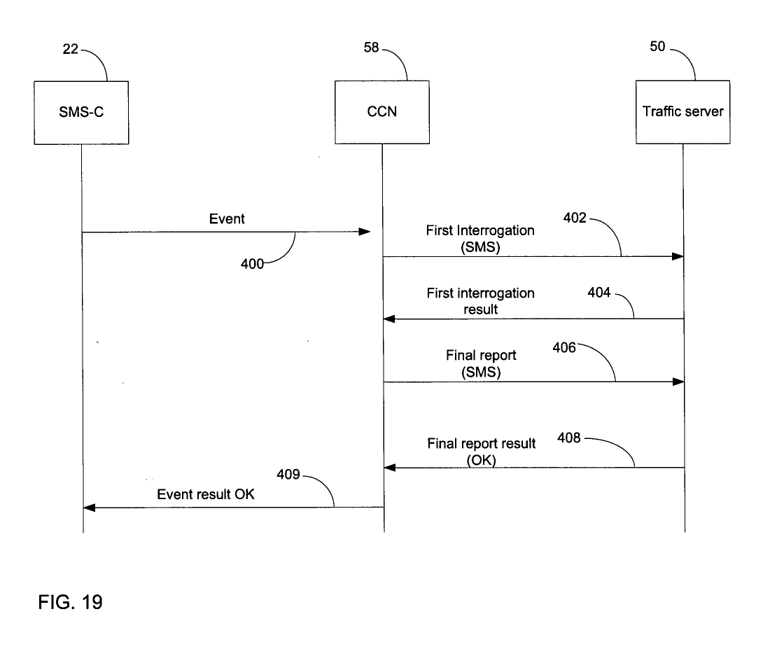

FIG. 19 is a signaling diagram illustrating an SMS event message flow. When the user attempts an SMS, the SMS-C 22 receives the request and sends a request to the CCN 58. The SMS-C checks if the subscriber is a subscriber to the selective restriction service, and, if so, the SMS-C requests an SMS message by sending an EVENT message 400 to the CCN. Upon receiving the EVENT message from the SMS-C, the CCN sends a First Interrogation (F1) Message 402 to the traffic server 50. On receiving the FI, the restriction conditions on the subscriber for day of week and time of day are checked by the traffic server. If there are no restrictions, the traffic server checks to determine if there are any restrictions due to limits set on the number of SMS in the IM/SMS bucket. The traffic server then sends a FI result message 404 to the CCN. The CCN immediately sends a FR message 406 to the traffic server to finalize the reservation. Thus, an SMS is deducted in the IM/SMS bucket before the CCN replies to a “success” to the SMS-C. In response, the traffic server sends a FR result OKAY message 408 to the CCN. The CCN then sends an EVENT result OK message 409 to, the SMS-C ay sending a CDR for post processing.

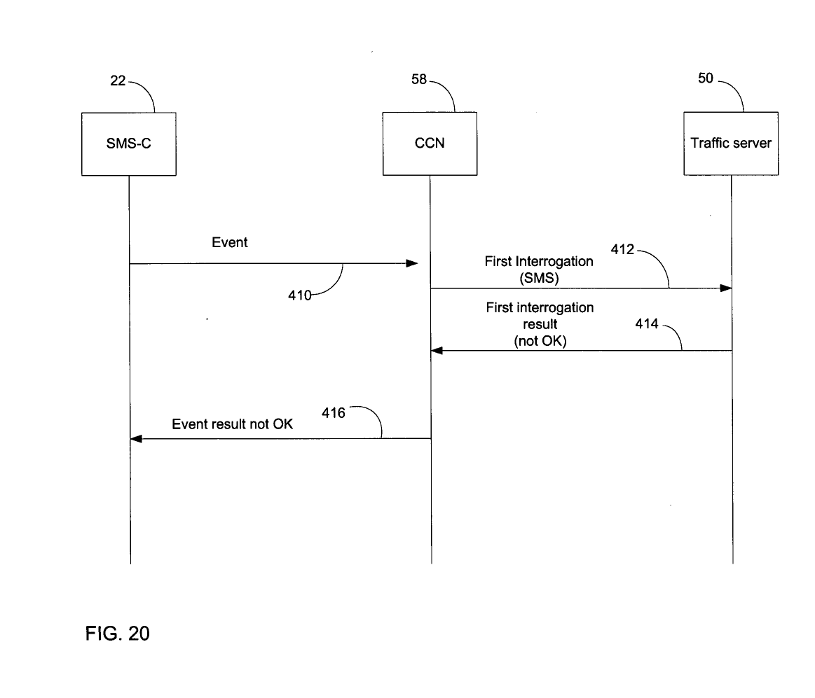

FIG. 20 is a signaling diagram of a restriction condition for an SMS event. In the case the SMS is not delivered to the user, there may be a separate request from the SMS-C 22, which sends an EVENT message 410 indicating the SMS delivery status. The CCN 58 sends a FI message 412 to the traffic server 50. The traffic server checks the SMS delivery status and if it states “not delivered”, then it credits the SMS bucket without performing the restriction check process. The traffic server then sends a FI result message 414 to the CCN. The CCN then sends an event result not OK message 416 to the SMS-C. In the scenario discussed in FIG. 20, a restriction condition is met (either the day of week, item of day or the number of SMS are all used up). Upon receiving the denial message due to restrictions, it is the responsibility of the SMS-C to convey to the subscriber that the SMS request has been denied due to restrictions.

If a threshold has been reached for the SMS bucket, then a USSD notification is sent to the subscriber indicating that the threshold limits are reached. The threshold check is conducted by the traffic server after every SMS deduction. The traffic server actually sends the USSD information to the HLR for delivery to the subscriber. The USSD is forwarded to the MSC/VLR where the subscriber is registered. For any non-billable SMS numbers, the present invention may not be utilized.

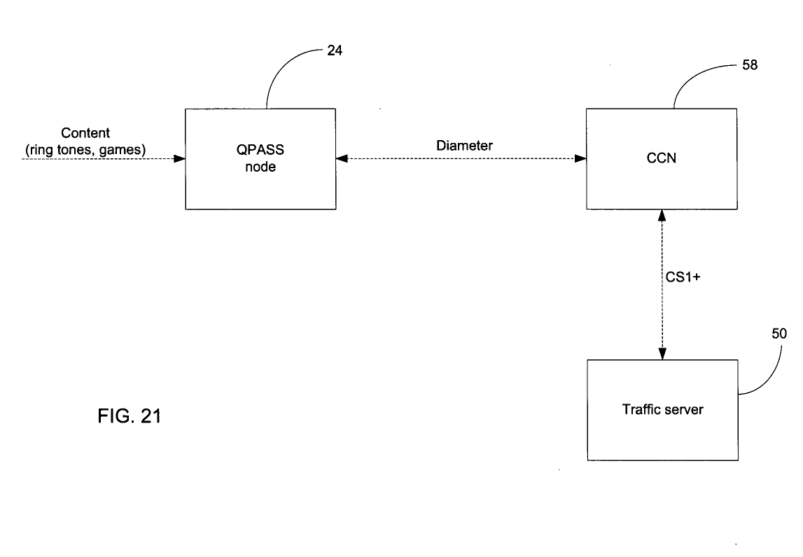

FIG. 21 is a simplified block diagram of content download by subscribers through the QPASS node 24. When a content download is initiated from a postpaid subscriber, the call is routed to the QPASS node. If it is a subscriber having the selective restriction service, the QPASS node routes the call to the CCN to check if the content event should be allowed. The CCN forwards this request to the traffic server, which has all the rules and restrictions stored for content set by the administrator through the web GUI. If the restrictions (limits on the content bucket) are not reached, then a “successful” reply is sent to the CCN, which, in turn, is sent to the QPASS node to continue the content download. Content downloads are deducted from the separate buckets within the traffic server. Minimum deduction amount may be in dollar or in cents.

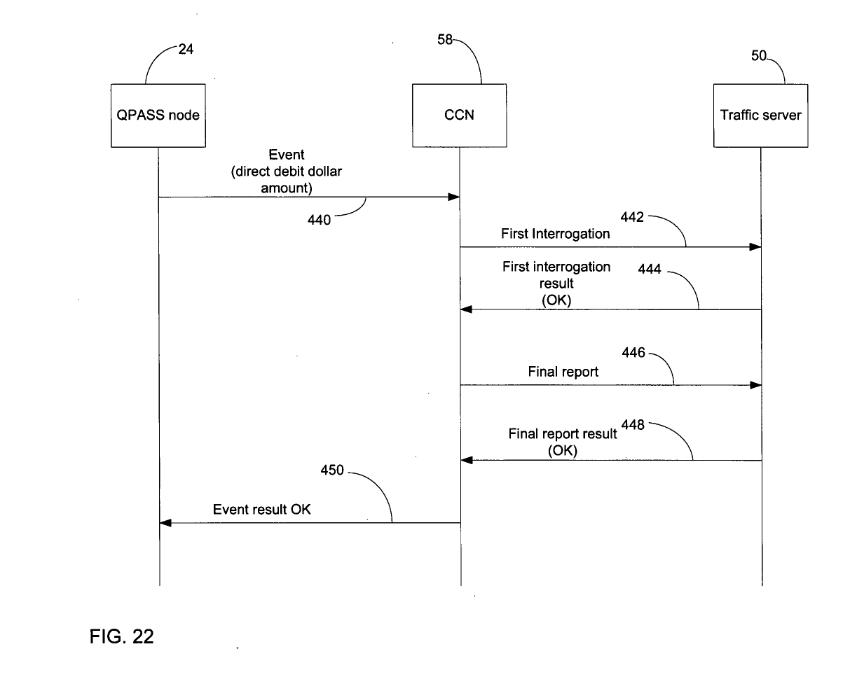

When the user attempts a download of content, the QPASS node 24 receives the request and sends a request to the CCN 58. FIG. 22 is a signaling diagram of the flow of message for a content event. The QPASS node checks if the subscriber subscribes to the selective restriction service and, if so, then requests content download by sending an EVENT message 440 to the CCN. Content is handled as an event with direct debit. For one-time events, a debit is made for the service without doing a reservation. If the execution of the service is not successful, the service element must refund the previously deducted amount by making a refund account operation. The QPASS node specifies in an event message 440, a debit and the amount to be deducted. Upon receiving the event message, the CCN sends a FI message 442 to the traffic server 50. On receiving the FI message, the traffic server checks for any restrictions due to limits on the dollar amount set. In addition, the content buckets, as well as time and day restrictions, are checked. If there are no restrictions, it sends a successful reply 444 to the CCN. The CCN immediately sends a FR message 446 to finalize the reservation. Thus, the dollar amount is deducted from the content bucket before the CCN replies successfully to the QPASS node. The traffic server sends a FR result OK 448 to the CCN. The QPASS node then allows the content download to continue and generates a CDR (Event result OK message 450) for post processing. In the scenario where the content is not delivered, there may be a separate request from the QPASS node which sends a refund event with the amount to be refunded. When the refund event is conveyed by the CCN to the traffic sever, it directly credits the account without getting into the restriction check routine.

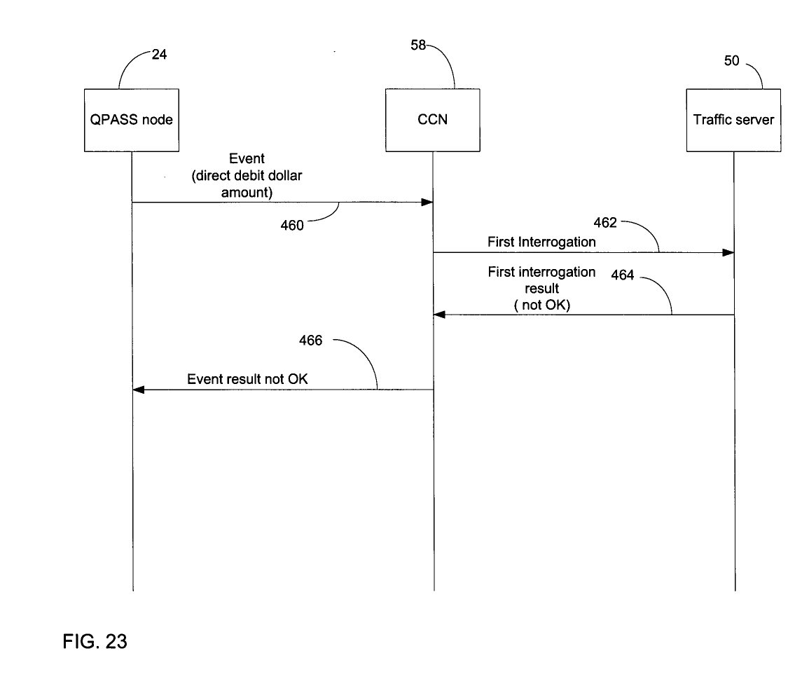

FIG. 23 is a signaling diagram illustrating a content restriction condition message flow. In FIG. 23, a restriction condition is met (e.g., dollar amount allocated is used up). The traffic server 50 sends an “unsuccessful” reply to the CCN 58 which, when conveyed to the AC node, denies the content request from the QPASS node. On receiving the denial message due to restrictions, the QPASS node conveys to the subscriber that the content request has been denied due to restrictions. Referring to FIG. 23, the QPASS node 24 sends an event message 460 to the CCN. The CCN sends a FI message 462 to the traffic server. The traffic server then sends a FI result (not OK) 464 to the CCN. The CCN then sends an event result not OK message 466 to the QPASS node.

If the threshold has been reached for the content bucket, a USSD notification is sent to the user indicating that the threshold limits are reached. The traffic server then checks the threshold condition after every deduction from the content bucket. The traffic server sends the USSD information to the HLR for further delivery to the subscriber. The USSD is forwarded to the MSC/VLR where the subscriber is registered. In addition, in the preferred embodiment of the present invention, no partial reservations are conducted for content. For instance, if content request is 1.00 cents and if the SDP has one dollar, then it will not do a partial reservation and will deny the request. Exact amount for content purchases are deducted. For example, if a content purchase for ring tones is 2.49 cents, then 2.49 cents would be deducted.

The switch control master nodes are responsible for provisioning the subscriber with the selective restriction service on the provisioning server. Preferably, this provision is conducted using the SOAP/HTTP interface. The interface allows for three functions: add a user to the traffic server; delete a user from the traffic server; and change at least one parameter of the user. To add a subscriber to the traffic server, the switch master/switch control sends an “add user” method over simple object access protocol/hypertext transport transfer protocol (SOAP/HTTP) to the provisioning server providing the data for various parameters, such as MSISDN of the subscriber, bill cycle date for the subscriber, email address of the administrator, and account identification of the administrator. Upon receiving the data, the provisioning server parses the SOAP parameters and verifies the correctness. It then retrieves the rate plan information for the subscriber from the CSI 32 and pushes the new subscriber and his details to the traffic server 50. The provisioning server then sends an email with information on how to access the web interface to the administrator through the SMTP server.

The switch control master 30 is utilized to delete a subscriber from the traffic server. The switch control master sends a delete user method over SOAP/HTTP to the provisioning server providing the MSISDN of the subscriber to be deleted. Upon receiving this date, the provisioning server pareses the SOAP parameters and pushes the request to the traffic server 50. On error, the server sends back an error message with a text indicating the error. Since the MSISDN is unique, the traffic server is able to locate the entry in the database and delete all the data related to this subscriber. The provisioning server then sends an email to the administrator through the SMTP server 52. The SMTP server is interconnected to the network nodes, which eventually sends the message to the administrator.

To change parameters, the switch control master 30 sends a change parameter method over SOAP/HTTP to the provisioning server 40 providing one or more of the following parameters: old mobile station integrated service digital network (MSISDN) of the user; new MSISDN of the user; bill cycle date of the user; email address of the administrator; account identification of the administrator; and rate plan change.

The present invention provides an enhanced traffic server capable of checking several restrictions prior to performing an action. Additionally, the present invention provides a user interface allowing the subscriber (administrator) to select the restrictions to apply to the specific user equipment. It should be understood that the implementation, including the various nodes and signaling messages may vary and still remain in the scope of the present invention.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates all modifications that fall within the scope of the invention defined by the following claims.

1. A method of selectively restricting usage of a user equipment (UE) in a telecommunications system, the method comprising the steps of:
receiving a plurality of restrictions, each restriction providing a constraint on use of the UE;
determining if usage of the UE is within one of the restrictions; and
upon determining if usage of the UE is within one of the restrictions, restricting usage of the UE.

2. The method of selectively restricting usage of a UE of claim 1 wherein the step of receiving a plurality of restrictions includes providing a graphical user interface (GUI) for a user to select and modify a restriction to restrict the usage of the UE.

3. The method of selectively restricting usage of a UE of claim 2 wherein the GUI is accessible via the Internet.

4. The method of selectively restricting usage of a UE of claim 1 wherein the step of determining if usage of the UE is within one of the restrictions includes a traffic server receiving the restrictions and determining if usage of the UE is within one of the restrictions.

5. The method of selectively restricting usage of a UE of claim 4 wherein the step of restricting usage of the UE includes terminating a call of the UE by the traffic server.

6. The method of selectively restricting usage of a UE of claim 1 further comprising the steps of:
determining a threshold limit approaching a limit of the restriction; and
informing a user when the UE exceeds the threshold limit.

7. The method of selectively restricting usage of a UE of claim 1 wherein:
a restriction on a day of the week for which the UE is restricted is received; and
upon determining if usage of the UE is conducted on a restricted day of the week, restricting usage of the UE.

8. The method of selectively restricting usage of a UE of claim 1 wherein a restriction on a time of day for which the UE is restricted is received and upon determining if usage of the UE is conducted on a restricted time of the week, restricting usage of the UE.

9. The method of selectively restricting usage of a UE of claim 1 wherein a restriction on a geographical location for which the UE is restricted is received and upon determining if usage of the UE is conducted within the restricted geographical location, restricting usage of the UE.

10. The method of selectively restricting usage of a UE of claim 9 wherein an administrator of the UE is informed when the UE is within the restricted geographical location.

11. The method of selectively restricting usage of a UE of claim 1 wherein the plurality of restrictions includes a restriction on a day of the week, a restriction on a time of day, and a restriction on a geographical location; and the step of restricting usage of the UE includes:
upon determining if usage of the UE is conducted on a restricted day of the week, restricting usage of the UE; upon determining if usage of the UE is conducted on a restricted time of the week, restricting usage of the UE; and upon determining if usage of the UE is conducted within the restricted geographical location, restricting usage of the UE.

12. The method of selectively restricting usage of a UE of claim 1 wherein the plurality of restrictions includes restrictions on a voice call of the UE.

13. The method of selectively restricting usage of a UE of claim 1 wherein the plurality of restrictions includes restrictions on a data call of the UE.

14. The method of selectively restricting usage of a UE of claim 13 wherein the plurality of restrictions includes a restriction on a day of the week and a restriction on a time of day; and the step of restricting usage of the UE includes:
upon determining if usage of the UE is conducted on a restricted day of the week, restricting data usage of the UE; and
upon determining if usage of the UE is conducted on a restricted time of the week, restricting data usage of the UE.

15. The method of selectively restricting usage of a UE of claim 14 wherein the data usage is associated with a short message service (SMS) message.

16. The method of selectively restricting usage of a UE of claim 14 wherein the data usage is associated with a content download by the UE.

17. The method of selectively restricting usage of a UE of claim 14 wherein the data usage is associated with instant messaging (IM).

18.-33. (canceled)

34. A node for selectively restricting usage of a user equipment (UE) in a telecommunications system, the node comprising: receiver means for receiving a plurality of restrictions, each restriction providing a constraint on use of the UE; restriction determination means for determining if usage of the UE is within one of the restrictions; and usage restricting means for restricting usage of the UE upon determining if usage of the UE is within one of the restrictions.

35. The node for selectively restricting usage of a UE of claim 34 wherein the node is a traffic server.

36. The node for selectively restricting usage of a UE of claim 35 wherein the traffic server terminates a call when restricting usage of the UE.

37. The node for selectively restricting usage of a UE of claim 35 wherein the traffic service includes: threshold determination means for determining a threshold limit approaching a limit of the restriction; and transmitting means for informing a user when the UE exceeds the threshold limit.

38. The node for selectively restricting usage of a UE of claim 35 wherein: the plurality of restrictions includes a restriction on a day of the week, a restriction on a time of day and a restriction on a geographical location; and the traffic server restricts usage of the UE upon determining if usage of the UE is conducted on a restricted day of the week, a restricted time of the day or a restricted geographical location.
